(19) United States
(12) Patent Application Publication
(10) Pub. No.: US 2021/0099498 A1
(43) Pub. Date: Apr. 1, 2021

(54) SECURITY HEADERS FOR CLOUD-NATIVE APPLICATIONS

(71) Applicant: SAP SE, Walldorf (DE)

(72) Inventors: Patrick Spiegel, Karlsruhe (DE); Nils Neumann, Offenbach am Main (DE)

(21) Appl. No.: 16/585,655

(22) Filed: Sep. 27, 2019

(51) Int. Cl. H04L 29/06; H04L 29/08

(52) U.S. Cl. CPC H04L 65/1069; H04L 65/104; H04L 67/02; H04L 63/0428; H04L 69/22

(57) ABSTRACT

A request is received by a gateway. A response to the request is received by the gateway. It is determined that the request comprises a User-Agent request header. In response to determining that the request comprises a User-Agent request header, a type setting of a Content-Type response header is determined. In response to determining that the type setting of the Content-Type response header indicates HTML content, a security header is added to the response. The response responsive to the request is returned.

### BACKGROUND

The World Wide Web (“WWW” or “web”) as known today evolved over more than two decades. To enable increasingly complex applications (“apps”), many new technologies and standards were introduced during this time period. These standards and technologies introduced several new classes of security attacks and privacy issues. While some of these security and privacy issues could be addressed and solved, other issues exist due to backward-compatibility and problems anchored in fundamental mechanisms of the WWW. Hypertext Transfer Protocol (HTTP) security headers can be added to address some of the attack classes. For example, currently, ten security headers are recommended by the Open Web Online Security Project (OWASP) for use in securing a web-application (such as, countermeasures against cross-site scripting, clickjacking, man-in-the-middle attacks and data leaks). Enforcing security headers across entire cloud landscapes and clusters can be problematic.

### SUMMARY

The present disclosure describes an approach to automatically enforce security headers across entire cloud landscapes and clusters.

In an implementation, a request is received by a gateway. A response to the request is received by the gateway. It is determined that the request comprises a User-Agent request header. In response to determining that the request comprises a User-Agent request header, a type setting of a Content-Type response header is determined. In response to determining that the type setting of the Content-Type response header indicates Hypertext Markup Language (HTML) content, a security header is added to the response. The response responsive to the request is returned.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, security headers can be configured and maintained centrally and secure, by-default, entire cloud environments. Therefore, typical non-configuration and miss-configuration errors can be prevented and security standards can be ensured. Second, Application developers need only deal with security headers if there are application-specific requirements. Third, security headers can be employed only when actually required. By understanding when security headers are needed, unnecessary transfer of security headers can be avoided, which can minimize processing and traffic impacts. Fourth, the presented approach is compatible for new and legacy applications, and legacy code can be run without changes. Fifth, knowledge of a precise distinction of relevance or non-relevance of security headers for responses in relation to security implications can enhance overall system security.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

DESCRIPTION OF DRAWINGS

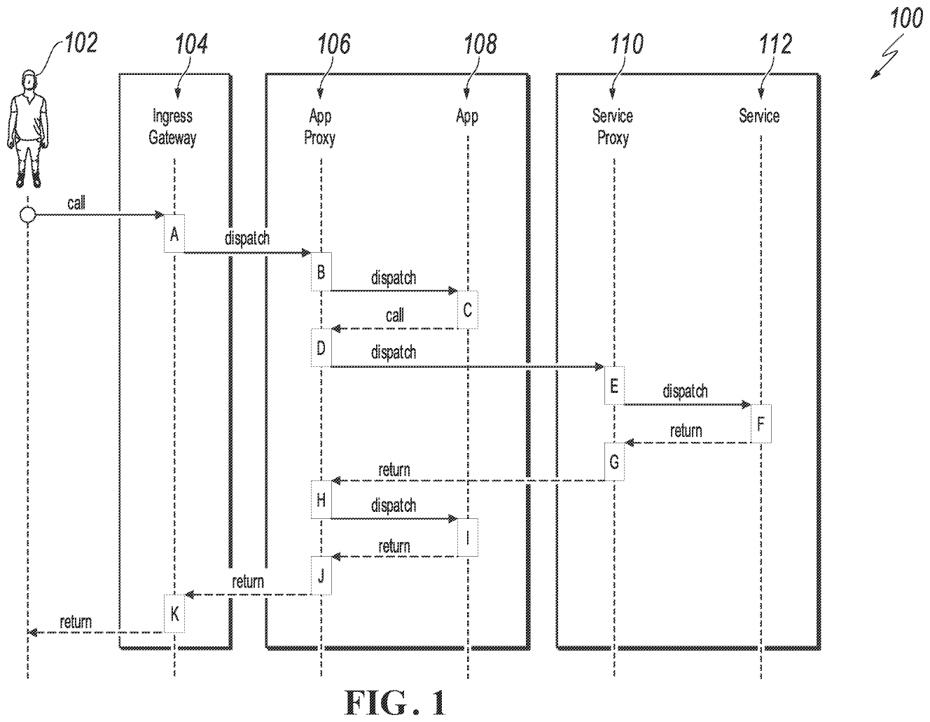

FIG. 1 is a sequence diagram illustrating an example of a call to an application with a backing service in a cloud-native environment, according to an implementation of the present disclosure.

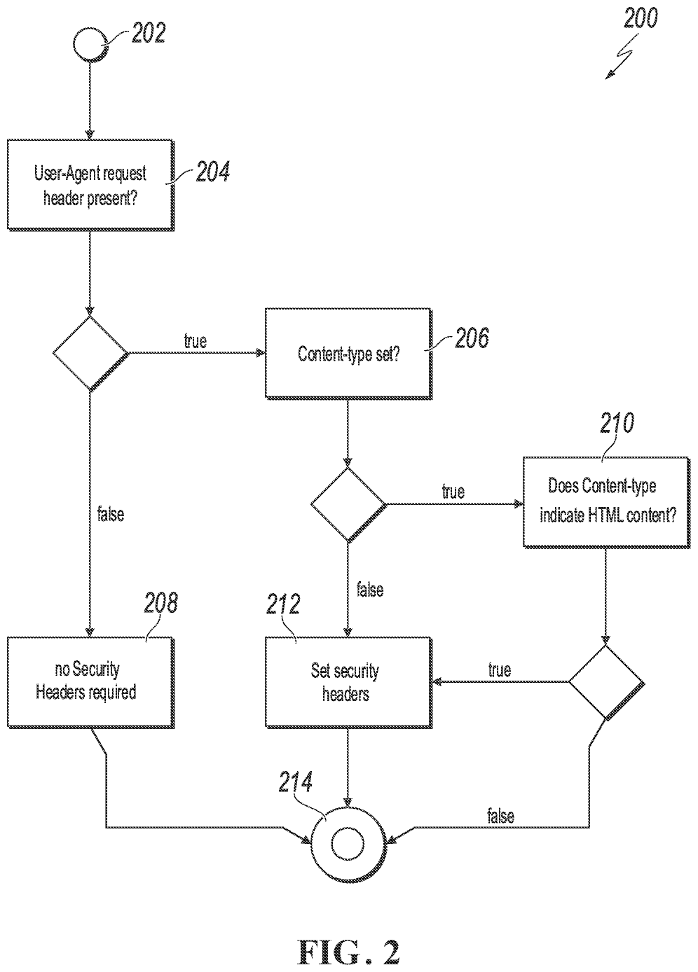

FIG. 2 is a flowchart illustrating an example of a computer-implemented method for determining if a security header is required for a response, according to an implementation of the present disclosure.

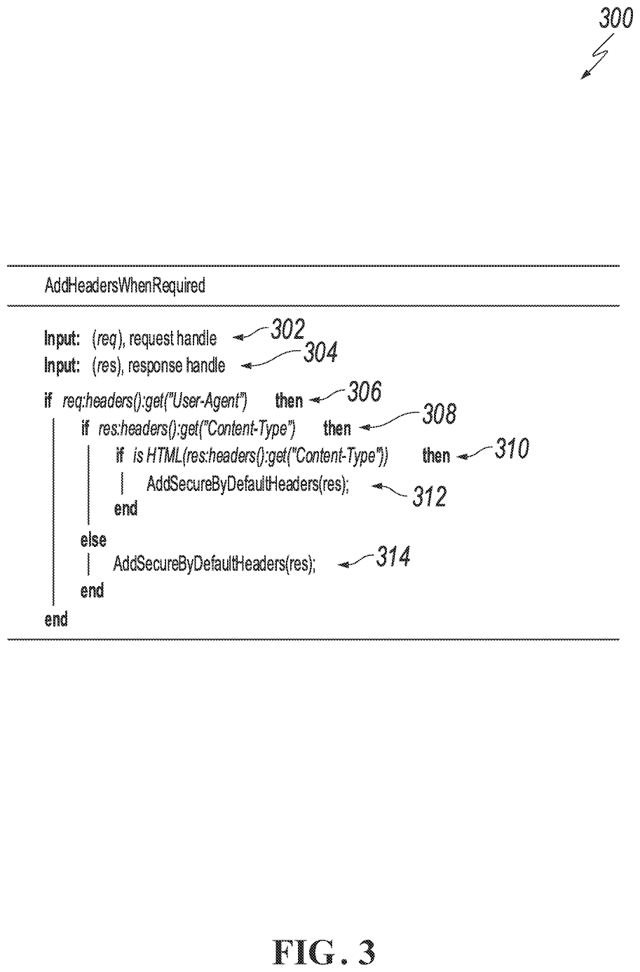

FIG. 3 is pseudocode illustrating an example of a possible implementation of the method of FIG. 2 for an ingress gateway, according to an implementation of the present disclosure.

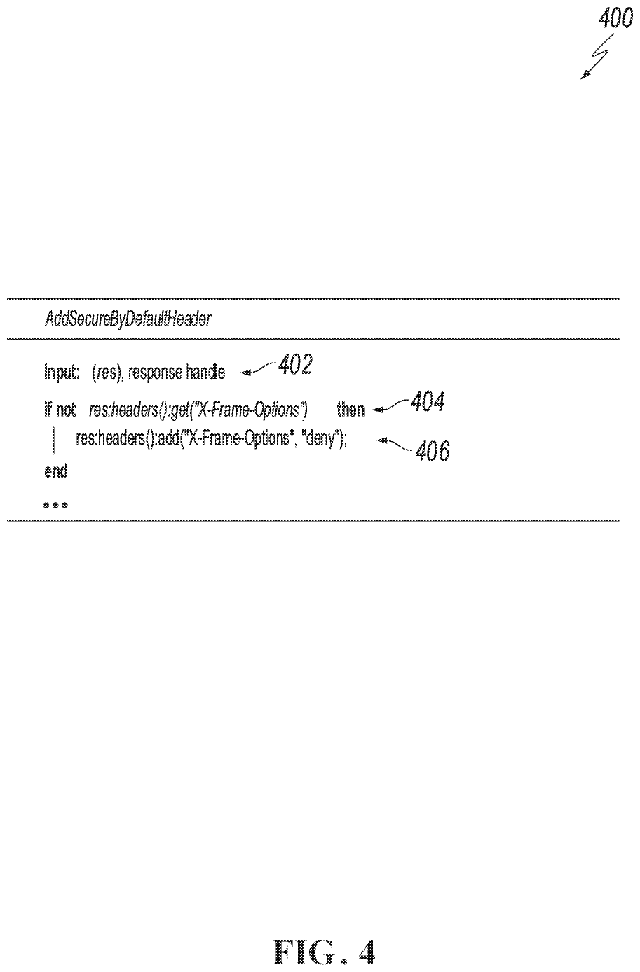

FIG. 4 is pseudocode illustrating an example of a computer-implemented method for determining if a security header is required for a response, according to an implementation of the present disclosure.

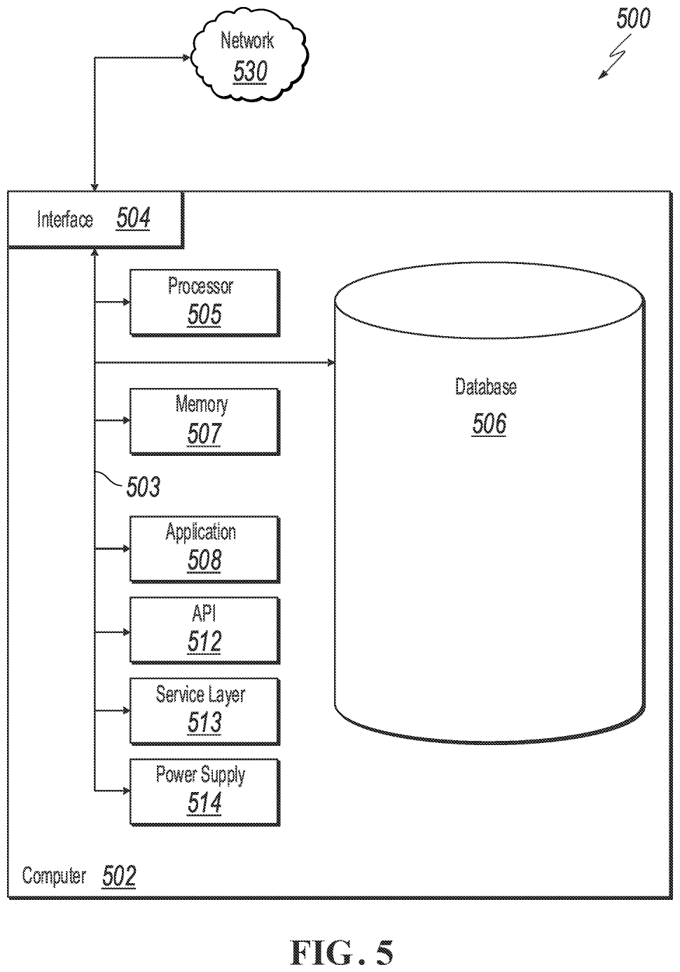

FIG. 5 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes an approach to automatically enforce security headers across entire cloud landscapes and clusters, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

The World Wide Web (“WWW” or “web”) as known today evolved over more than two decades. To enable increasingly complex applications (“apps”), many new technologies and standards were introduced during this time period. These standards and technologies introduced several new classes of security attacks and privacy issues. While, some of these security and privacy issues could be addressed and solved, other issues exist due to backward-compatibility and problems anchored in fundamental mechanisms of the WWW. Hypertext Transfer Protocol (HTTP) security headers can be added to address some of the attack classes. Browser vendors and the World Wide Web Consortium (W3C) introduced several, optional HTTP security headers. For example, currently, ten security headers are recommended by the Open Web Online Security Project (OWASP) for use in securing a web-application (such as, countermeasures against cross-site scripting, clickjacking, man-in-the-middle attacks and data leaks). Enforcing security headers across entire cloud landscapes and clusters can be problematic.

These headers allow application developers to enable additional security mechanisms within the browsers for a website. However, by default, these security mechanisms cannot be enabled, because they might break existing applications by restricting required browser functionality. In some cases, developers can decide which security mechanisms and what degree of security is appropriate for applications served to the browser.

While security headers are required to securely operate most applications, configuration is normally performed manually for each application. Manual approaches are prone to errors. As a result, HTTP security headers can often be forgotten or misconfigured (for example, in a non-secure manner). On the one hand, browser vendors are not less-than-willing to change default behaviors to not break existing application (for example, a website, mobile device application) functionality. On the other hand, corporate security standards typically require security headers to be employed for each application in a production environment. This situation causes tension between application functionality and required security requirements.

This problem is magnified when operating in a cloud landscape. A platform provider is required to run customer applications securely as well as their own applications. That is why a secure-by-default approach for entire cloud landscapes or clusters is desirable. Current solutions try to tackle this problem by putting configurable reverse-proxies in front of each application. These proxies allow headers to be set for each application endpoint. However, this configuration can cause unnecessary cloud landscape processing and traffic overhead when security headers for a browser are not required but included. For example, cloud internal service-to-service or application-to-service calls ignore security headers meant for the browser. In this case, including security headers can result in a waste of computational resources.

The current disclosure describes a possible solution to this problem. Requirements of the solution include:

Requirement 1: Security headers can be set centrally and secure, by-default, an entire cloud landscape or cluster;

Requirement 2: Security headers can be configured for application-specific requirements;

Requirement 3: Security headers may be employed only when necessary to allow for zero overhead.

Existing approaches manually configure security headers within an application or an application proxy. As experience has shown, the manual approaches can be prone to human error, misunderstanding of correct configurations or a lack of configuration. The described approach can secure all apps and services in a cloud-native environment by default. Adaptions for application-specific requirements or legacy applications are compatible with existing solutions.

Existing approaches employ security headers for each and every response in order to catch the few cases where security are needed. In the described approach, knowledge of a precise distinction of relevance or non-relevance of security headers for responses in relation to security implications can enhance overall system security.

The described solution is lightweight in terms of resource consumption and response latency. Through an employed user-agent and MIME (Multipurpose Internet Mail Extensions)-type (“media type” or “content type”) sensitivity, headers may be added only when which can prevent negative impacts on system traffic volume as well as processing time, while preserving system and application security features.

FIG. 1 is a sequence diagram illustrating an example of a call to an application with a backing service in a cloud-native environment 100, according to an implementation of the present disclosure. The cloud-native environment 100 includes, for example, an Ingress Gateway 104, an App Proxy 106, an App 108, a Service Proxy 110, and a Service 112. The sequence diagram in FIG. 1 shows an example of how security headers can be implemented secure-by-default for cloud-native environments.

In some implementations, a user 102 initiates a request to an App 108 with a backing Service 112. The request from the user 102 can enter the cloud environment 100 through a central component called Ingress Gateway 104. Some existing Platform as a Service (PaaS) or Software as a Service (SaaS) solutions (such as, KUBERNETES, CLOUDFOUNDRY or OPENSHIFT) can include functionality that can be leveraged to assist in solving the described problem—a central ingress endpoint (for example, the Ingress Gateway 104). In practice, this means all requests to an app or service running on the cloud platform can be routed through a central component. This can apply to PaaS as well as Software as a Service (SaaS) offerings. This Ingress Gateway 104 can be, depending on the platform, implemented as a reverse-proxy or load-balancer (such as, NGINX or ENVOY). The user request may not on be from a browser, but also from an external application or an external service. The Ingress Gateway 104 can route the request to the respecting App 108 which in turn can be coupled with the App Proxy 106. When the App 108 calls the Service 112 within the cloud environment 100, the request can be routed back through the App Proxy 106 and forwarded to the respecting Service 112. This Service 112 in turn can be coupled with a Service Proxy 110. To complete the initial user request, responses can be routed in the opposite sequence through the Service Proxy 110, the App Proxy 106, the App 108, again the App Proxy 106 and finally the Ingress Gateway 104.

Current cloud environments may implement security headers in the App 108/Service 112 (I/F) or configure them in the App Proxy 106/Service Proxy 110 (J/G). This approach can have two major drawbacks. First, security headers may have to be set or configured manually for every single application. Second, security headers may be sent for each cloud-internal response causing unnecessary traffic overhead.

To address previously described Requirement 1 and Requirement 3, security headers can be ensured for all responses leaving the cloud environment 100. With regards to a cloud-native architecture (for example, as is FIG. 1), all outgoing responses can be processed by the Ingress Gateway (K) 104, which can set security headers centrally and by-default and can minimize traffic overhead for internal cloud landscape communication. In practice and in some implementations, the Ingress Gateway (K) 104 can be an HTTP (L7) proxy (such as, NGINX, HA-PROXY, or ENVOY).

FIG. 2 is a flowchart illustrating an example of a computer-implemented method 200 for determining if a security header is required for a response, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

At 202, a request is received by a gateway and a response to the request is received by the gateway. In some implementations, the gateway can be an ingress gateway of a cloud environment, where the ingress gateway can process all outgoing responses from the cloud environment to a plurality of users. The cloud environment can include a plurality of applications and a plurality of application proxies. In some implementations, the ingress gateway can be an HTTP proxy. In some implementations, the received request is initiated by a user and the response is generated by processing the received request in the cloud environment. From 202, method 200 proceeds to 204.

At 204, it is determined whether the request includes a User-Agent request header. At least one reason why the determination is made is because: by implementing the solution in the Ingress Gateway (for example, 104 in FIG. 1) instead of the single app proxies (for example, 106 in FIG. 1), the cloud internal processing and traffic overhead can be saved; however, in some cases, there can be significant overhead when setting security headers by default for each response in the Ingress Gateway (for example, 104 in FIG. 1). In this case, it makes sense to only set security headers when the client is a browser that interprets the headers. However, calls to a cloud-environment can also derive from other cloud-environments, applications, and services. In these cases, security headers can be pure overhead. Identifying external requests that derive from a browser can be accomplished by checking the User-Agent header in the request. When this header is not set in the request, there may not be a need to set security headers in the response. Since common Ingress Gateways (such as, ENVOY, NGINX, or HA-PROXY) can represent ISO/OSI L7 Proxies, HTTP request and response headers can be already parsed for each request and response. Thus, checking for the User-Agent request header may not represent a significant overhead. In response to determining that the request does not include the User-Agent request header, the response responsive to the request can be returned. If it is determined that the request includes a User-Agent request header, method 200 proceeds to 206. Otherwise, if it is determined that the request does not include a User-Agent request header, method 200 proceeds to 208.

At 206, it is determined whether the response comprises a set Content-Type response header. In some implementations, browsers interpret the security headers of the initial page request but ignore the ones sent with resources such as images and scripts for the same page. Thus, security headers can be relevant for initial requests, but not sub-resources. Initial requests can be identified by the content-type of the response. In some cases, some or all Hypertext Markup Language (HTML)-like content-types can be relevant. Others like image, CSS and JavaScript content-types may not require security headers. In some implementations and as previously mentioned, this distinction between content-types is referred to as MIME-type sensitivity. Adding MIME-type sensitivity to secure-by-default header logic in the Ingress Gateway can further minimize processing and traffic overhead. In some implementations, and in response to determining that the response comprises a Content-Type response header that is not set, a security header is added to the response by default without further analyzing the content type of the response. In some implementations, in response to determining that the response comprises a Content-Type response header that is not set, further analysis on the response (for example, examining the data packets of the response) is conducted to judge if the content type indicates HTML content. If it is determined that the response comprises a Content-Type response header that is set, method 200 proceeds to 210. Otherwise, if it is determined that the response does not comprise a Content-Type response header that is set, method 200 proceeds to 212.

At 208, in response to determining that the request does not include a User-Agent request header, no security headed is added to the response. From 208, method 200 proceeds to 214.

At 210, it is determined whether a type setting of the Content-Type response header indicates HTML content. For example, the Content-Type response header can be set to HTML, Extensible Hypertext Markup Language (XHTML), or other markup language to indicate HTML content. As understood by a person of skill in the art, a markup language is a type of language for annotating text or embedding tags in a styled electronic document. Although the present disclosure describes in the context of HTML content, other type settings are also possible. If it is determined that the type setting of the Content-Type response header indicates HTML content, method 200 proceeds to 212. Otherwise, if it is determined that the type setting of the Content-Type response header is not a markup language, method 200 proceeds to 214.

At 212, a security header is added to the response. In some implementations, the set of security headers to be set by default can be taken from a corporate security standard or the OWASP Secure Headers Project. In some implementations, the required information to identify the cases where security headers are actually required is already available within an L7 HTTP proxy. From 212, method 200 proceeds to 214.

At 214, the response responsive to the request is returned. In some implementations, the received request is initiated by the user and the response is returned to the user. After 214, method 200 can stop.

FIG. 3 is pseudocode 300 illustrating an example of a possible implementation of the method of FIG. 2 for an ingress gateway, according to an implementation of the present disclosure. Pseudocode 300 is only one of many possible implementations as will be understood by one of ordinary skill in the art. The described solution is not meant to be limited by the particular example of FIG. 3. In some implementations, the pseudocode 300 includes an input 302 (that is, a request (req) and a request handle), an input 304 (that is, a response (res) and a response handle). At line 306, it is determined whether the request includes a User-Agent request header. If it is determined that the request includes a User-Agent request header, pseudocode 300 proceeds to 308. At line 308, it is determined whether the response comprises a Content-Type response header that is set. If it is determined that the response comprises a Content-Type response header that is set, pseudocode 300 proceeds to 310. Otherwise, if it is determined that the response does not comprise a Content-Type response header that is set, pseudocode 300 proceeds to 314. At line 310, it is determined whether a type setting of the Content-Type response header indicates HTML content. If it is determined that a type setting of the Content-Type response header indicates HTML content, pseudocode 300 proceeds to 312. At line 312, a security header is added to the response. At line 314, a security header is added to the response.

FIG. 4 is pseudocode 400 illustrating an example of a computer-implemented method for determining if a security header is required for a response, according to an implementation of the present disclosure. In some implementations, the pseudocode 400 includes an input 402 (that is, a response (res) and a response handle). In some implementations, per Requirement 2, a few applications require specific security header settings, and this is a reason why the solutions in the present disclosure have not yet been implemented in the outgoing Ingress Gateway. Pseudocode 400 shows an example of an approach to solve this problem by allowing each App or App Proxy to overrule the secure-by-default settings of the Ingress Gateway (K). In some implementations, when a certain security header is already set by the application (I) or application proxy (J), the settings of the Ingress Gateway (K) are overruled. This logic is outlined exemplary for X-Frame-Options in pseudocode 400 and can be implemented for an L7 Ingress Gateway. For legacy applications, the App Proxy could be simply configured to disable all security mechanisms in the browser. Still, all other applications in the cluster could run secure and with reduced overhead. With this fallback-logic in place, the given approach can also address the Requirement 2. In some implementations, this approach allows but strongly discourages to turn off security headers explicitly for legacy applications. Usually, compatibility issues can be solved with specific policies to make it hard to actually exploit vulnerabilities. Disabling features completely may cause security issues. At line 404, it is determined whether the response includes an “X-Frame-Options” header. If it is determined that the response does not include an “X-Frame-Options” header, pseudocode 400 proceeds to line 406. At line 406, an “X-Frame-Options” header and a “deny” header are added to the response.

In other words, the pseudocode 400 described in FIG. 4 is called by the pseudocode 300 described in FIG. 3. It should be noted that pseudocode 400 is only an example of an algorithm for handling the X-Frame options header. The same logic can apply to other headers.

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, System 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. As illustrated, the Database 506 can hold one or more data types consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

Described implementations of the subject matter can include one or more features, alone or in combination.

For example, in a first implementation, a computer-implemented method, comprising: receiving, by a gateway, a request; receiving, by the gateway, a response to the request; determining that the request comprises a User-Agent request header; in response to determining that the request comprises a User-Agent request header, determining a type setting of a Content-Type response header; in response to determining that the type setting of the Content-Type response header indicates HTML content, adding a security header to the response; and returning the response responsive to the request.

The foregoing and other described implementations can each, optionally, include one or more of the following features:

A first feature, combinable with any of the following features, further including determining whether the response comprises a Content-Type response header that is set.

A second feature, combinable with any of the previous or following features, further including determining that the Content-Type response header is set.

A third feature, combinable with any of the previous or following features, further including: in response to determining that the type setting of the Content-Type response header does not indicate HTML content, returning the response responsive to the request.

A fourth feature, combinable with any of the previous or following features, where the gateway is an ingress gateway of a cloud environment, where the ingress gateway processes all outgoing responses from the cloud environment to a plurality of users, and where the cloud environment comprises a plurality of applications and a plurality of application proxies.

A fifth feature, combinable with any of the previous or following features, where adding the security header to the response includes: determining that the response does not comprise an application-specific header, wherein the application-specific header is set by an application of the plurality of applications or an application proxy of the plurality of application proxies; in response to determining that the response does not comprise the application-specific header, adding the security header to the response.

A sixth feature, combinable with any of the previous or following features, further including: in response to determining that the request does not comprise the User-Agent request header, returning the response responsive to the request.

In a second implementation, a non-transitory, computer-readable medium storing one or more instructions executable by a computer system to perform operations comprising: receiving, by a gateway, a request; receiving, by the gateway, a response to the request; determining that the request comprises a User-Agent request header; in response to determining that the request comprises a User-Agent request header, determining a type setting of a Content-Type response header; in response to determining that the type setting of the Content-Type response header indicates HTML content, adding a security header to the response; and returning the response responsive to the request.

The foregoing and other described implementations can each, optionally, include one or more of the following features:

A first feature, combinable with any of the following features, further including determining whether the response comprises a Content-Type response header that is set.

A second feature, combinable with any of the previous or following features, further including determining that the Content-Type response header is set.

A third feature, combinable with any of the previous or following features, further including: in response to determining that the type setting of the Content-Type response header does not indicate HTML content, returning the response responsive to the request.

A fourth feature, combinable with any of the previous or following features, where the gateway is an ingress gateway of a cloud environment, where the ingress gateway processes all outgoing responses from the cloud environment to a plurality of users, and where the cloud environment comprises a plurality of applications and a plurality of application proxies.

A fifth feature, combinable with any of the previous or following features, where adding the security header to the response includes: determining that the response does not comprise an application-specific header, wherein the application-specific header is set by an application of the plurality of applications or an application proxy of the plurality of application proxies; in response to determining that the response does not comprise the application-specific header, adding the security header to the response.

A sixth feature, combinable with any of the previous or following features, further including: in response to determining that the request does not comprise the User-Agent request header, returning the response responsive to the request.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving, by a gateway, a request; receiving, by the gateway, a response to the request; determining that the request comprises a User-Agent request header; in response to determining that the request comprises a User-Agent request header, determining a type setting of a Content-Type response header; in response to determining that the type setting of the Content-Type response header indicates HTML content, adding a security header to the response; and returning the response responsive to the request.

The foregoing and other described implementations can each, optionally, include one or more of the following features:

A first feature, combinable with any of the following features, further including determining whether the response comprises a Content-Type response header that is set.

A second feature, combinable with any of the previous or following features, further including determining that the Content-Type response header is set.

A third feature, combinable with any of the previous or following features, further including: in response to determining that the type setting of the Content-Type response header does not indicate HTML content, returning the response responsive to the request.

A fourth feature, combinable with any of the previous or following features, where the gateway is an ingress gateway of a cloud environment, where the ingress gateway processes all outgoing responses from the cloud environment to a plurality of users, and where the cloud environment comprises a plurality of applications and a plurality of application proxies.

A fifth feature, combinable with any of the previous or following features, further including: in response to determining that the request does not comprise the User-Agent request header, returning the response responsive to the request.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A computer-implemented method, comprising:
receiving, by a gateway, a request;
receiving, by the gateway, a response to the request;
determining, by the gateway, whether the request comprises a User-Agent request header;
in response to determining that the request comprises a User-Agent request header, determining, by the gateway, a type setting of a Content-Type response header, wherein the Content-Type response header is comprised in the response; and
in response to determining that the type setting of the Content-Type response header comprised in the response indicates HTML content:
adding, by the gateway, a security header to the response; and
returning, by the gateway, the response.

2. The computer-implemented method of claim 1, further comprising:
determining whether the response comprises a Content-Type response header that is set.

3. The computer-implemented method of claim 2, further comprising:
determining that the Content-Type response header is set.

4. The computer-implemented method of claim 1, further comprising:
in response to determining that the type setting of the Content-Type response header does not indicate the HTML content, returning the response without the security header.

5. The computer-implemented method of claim 1, wherein the gateway is an ingress gateway of a cloud environment, wherein the ingress gateway processes all outgoing responses from the cloud environment to a plurality of users, and wherein the cloud environment comprises a plurality of applications and a plurality of application proxies.

6. The computer-implemented method of claim 5, wherein adding the security header to the response comprises:
determining that the response does not comprise an application-specific header, wherein the application-specific header is set by an application of the plurality of applications or an application proxy of the plurality of application proxies; and
in response to determining that the response does not comprise the application-specific header, adding the security header to the response.

7. The computer-implemented method of claim 1, further comprising:
in response to determining that the request does not comprise the User-Agent request header, returning the response without the security header.

8. A non-transitory, computer-readable medium storing one or more instructions executable by a computer system to perform operations comprising:
receiving, by a gateway, a request;
receiving, by the gateway, a response to the request;
determining, by the gateway, whether the request comprises a User-Agent request header;
in response to determining that the request comprises a User-Agent request header, determining, by the gateway, a type setting of a Content-Type response header, wherein the Content-Type response header is comprised in the response; and
in response to determining that the type setting of the Content-Type response header comprised in the response indicates HTML content:
adding, by the gateway, a security header to the response; and
returning, by the gateway, the response.

9. The non-transitory, computer-readable medium of claim 8, further comprising:
determining whether the response comprises a Content-Type response header that is set.

10. The non-transitory, computer-readable medium of claim 9, further comprising:
determining that the Content-Type response header is set.

11. The non-transitory, computer-readable medium of claim 8, further comprising:
in response to determining that the type setting of the Content-Type response header does not indicate the HTML content, returning the response without the security header.

12. The non-transitory, computer-readable medium of claim 8, wherein the gateway is an ingress gateway of a cloud environment, wherein the ingress gateway processes all outgoing responses from the cloud environment to a plurality of users, and wherein the cloud environment comprises a plurality of applications and a plurality of application proxies.

13. The non-transitory, computer-readable medium of claim 12, wherein adding the security header to the response comprises:
determining that the response does not comprise an application-specific header, wherein the application-specific header is set by an application of the plurality of applications or an application proxy of the plurality of application proxies; and
in response to determining that the response does not comprise the application-specific header, adding the security header to the response.

14. The non-transitory, computer-readable medium of claim 8, further comprising:
in response to determining that the request does not comprise the User-Agent request header, returning the response without the security header.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a gateway, a request;
receiving, by the gateway, a response to the request;
determining, by the gateway, whether the request comprises a User-Agent request header;
in response to determining that the request comprises a User-Agent request header, determining, by the gateway, a type setting of a Content-Type response header, wherein the Content-Type response header is comprised in the response; and
in response to determining that the type setting of the Content-Type response header comprised in the response indicates HTML content:
adding, by the gateway, a security header to the response; and
returning, by the gateway, the response.

16. The computer-implemented system of claim 15, further comprising:
determining whether the response comprises a Content-Type response header that is set.

17. The computer-implemented system of claim 16, further comprising:
determining that the Content-Type response header is set.

18. The computer-implemented system of claim 15, further comprising:
in response to determining that the type setting of the Content-Type response header does not indicate the HTML content, returning the response without the security header.

19. The computer-implemented system of claim 15, wherein the gateway is an ingress gateway of a cloud environment, wherein the ingress gateway processes all outgoing responses from the cloud environment to a plurality of users, and wherein the cloud environment comprises a plurality of applications and a plurality of application proxies.

20. The computer-implemented system of claim 15, further comprising:
in response to determining that the request does not comprise the User-Agent request header, returning the response without the security header.
